(19) United States
(12) Patent Application Publication
(10) Pub. No.: US 2009/0235580 A1
(43) Pub. Date: Sep. 24, 2009

(54) Garden Apparatus and Method

(76) Inventor: Terry N. Garrett, Athens, TN (US)

Correspondence Address: PITTS AND BRITTIAN P C, P O BOX 51295, KNOXVILLE, TN, 37950-1295, US

(21) Appl. No.: 12/053,278

(22) Filed: Mar. 21, 2008

(51) Int. Cl. A01G 9/14; A01G 9/00; A01G 9/16

(52) U.S. Cl. 47/17; 47/18

(57) ABSTRACT

A planter is accessible to a practitioner who occupies a wheelchair. This planter may be readily assembled from pieces that can be supplied to consumers in the form of a kit. The planter includes structures for illuminating, irrigating, and warming plants grown in the planter, as well as draining structures for removing excess water.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present invention relates generally to a planter. More particularly, the invention is directed toward a planter that is designed for use by an individual occupying a wheelchair.

2. Description of the Related Art

Planters are well known in the agricultural and gardening fields. Some planters known in the prior are, such as that described in U.S. Pat. No. 4,825,588 issued to Norman, include a central trough member supported by upstanding wall members. Plants are grown in a medium (usually soil) in the trough. By elevating the plants and media above the ground, the planter protects the plants from insects and ground animals, as well as from foot traffic and moderate flooding. Practitioners in the art have also found that use of a planter allows the practitioner more effectively and easily to control the composition and ingredients of the medium in which the plants are grown.

Planters offer particular advantages to those practitioners who occupy wheelchairs. If the planter is of proper elevation and is wheelchair-accessible, then the planter allows a practitioner who occupies a wheelchair to tend to the plants without having to bend or stoop. However, traditional planters are not designed for easy use by handicapped persons, particularly persons occupying wheelchairs. Thus, a need is felt for a planter that is designed to be wheelchair-accessible.

The incorporation of various structures onto the planter can further assist the wheelchair-bound practitioner and allow the practitioner more effectively and easily to control the conditions under which the plants grow and develop. For example, irrigation structures can supply the plants in the planter with controlled amounts of water at regular intervals; in this way an irrigation structure relieves the practitioner of the burden of manually watering the plants and of the risk of depending upon local weather conditions for irregular rain. Special lighting structures (hereinafter “grow lights”) can illuminate the plants, supplying the light necessary for photosynthesis. Heaters can help maintain the ambient temperature within the planter, insulating the plants from cold weather.

Adding some or all of these structures to a planter increases the degree of control that the practitioner exercises over the conditions under which the plants grow. Adding some or all of these structures is also of benefit to a wheelchair-bound practitioner, as the wheelchair-bound practitioner may find it more difficult to perform personally some of the tasks (such as watering plants) accomplished by these structures. However, ordinarily the addition of irrigating, illuminating, or heating structures requires specialized modification of the planter. In other words, these structures are standard components of most planters, and most planters are not designed with a view to incorporating these structures. Additionally, the specialized modification of a planter to incorporate these structures can be expensive.

Other devices have been developed to address these and other problems. Typical of the art are those devices disclosed in the following U.S. Patents:

| Patent Number | Inventor | Issue Date |
|---|---|---|
| 1,405,568 | Conklin | Feb. 7, 1922 |
| 4,825,588 | Norman | May 2, 1989 |
| 5,664,367 | Huang | Sep. 9, 1997 |
| 5,852,895 | Sinanan | Dec. 29, 1998 |
| Des. 428,828 | Gutierrez | Aug. 1, 2000 |
| 6,243,985 | Miller | Jun. 12, 2001 |

Of these patents, the '568 patent issued to Conklin describes a trough-shaped box. This trough-shaped box is composed of a piece of sheet metal bent at its ends partly around two circular wooden discs, which form the end walls of the trough. The box is secured to the wooden discs by screws or other suitable fasteners.

The '588 patent issued to Norman describes an apparatus and method of manufacture wherein a corrugated fiberglass trough is sealed between matching end walls, said walls consisting of stand and plug members which have sealing surfaces which match the contour of the fiberglass trough.

The '367 patent issued to Huang discloses an artistic flower planting case hangable on a building terrace having a flower planting case and a hanging plate. The hanging plate is channel shaped and placed on an upper surface of a terrace wall of a building. The flower planting case is an elongated case with an upper open side, forming an interior for soil and flowers. The case is assembled with the hanging plate by bolts screwing into a plurality of threaded holes in a rear side of the flower planting case and a front side of the hanging plate.

The '895 patent issued to Sinanan describes a planter assembly that includes a planter box and a support structure for the planter box. The support structure is formed by an elevating post, a base beneath the post and a planter box support atop the post. The post is releasably secured within the support structure which enables height adjustment trimming and then refitting of the post with the support structure.

The '828 design patent issued to Gutierrez describes a modular planter.

The '985 patent issued to Miller describes an automatic watering system. The device of the 985 patent includes a variety of interconnecting parts to form one or more separate elongate trays which are arrange in any fashion but generally one above the next. Each linear or radial tray section is adapted for supporting one or more potted plants. Trays are interconnected by flexible tubes so that when water is introduced into an upper tray it flows downwardly into subsequent lower trays. Trays are inexpensively fabricated by an extrusion process and when attached at both ends to end sections, form a finished shelf into which water may be introduced so as to hydrate and feed the plants by root absorption. The end sections are held in place by a snap on cover which also engages a screen to provide an effective watering tray and a clog free system.

### BRIEF SUMMARY OF THE INVENTION

A planter is disclosed. This planter is designed so that a wheelchair-bound practitioner may access the planter and tend to plants. The planter is readily assembled from pieces that can be supplied to consumers in the form of a kit. The planter includes structures for illuminating, irrigating, and warming plants grown in the planter, as well as draining structures for removing excess water.

### BRIEF DESCRIPTION OF THE DRAWINGS

The above-mentioned features of the invention will become more clearly understood from the following detailed description of the invention read together with the drawings in which:

FIG. 1 is a perspective view of one embodiment of the invention, showing the planter with its canopy in the “closed” position;

FIG. 2 is a perspective view of one embodiment of the invention, showing the planter with its canopy in the raised or “open” position, revealing the plants growing in the trough;

FIG. 3 is an elevation view of one embodiment of the invention;

FIG. 4 is an elevation view from one end of the planter, showing the canopy raised on hinges in the open position;

FIG. 5 is a perspective view of the planter's support apparatus, showing the brackets that secure the support apparatus;

FIG. 6 is an elevation view of one end of the planter, showing a heater on one end of the planter and heaters on the underside of the trough;

FIG. 7 is a plan view of the interior of the canopy, showing heaters and an illumination structure;

FIG. 8 is a bottom view of the planter trough, showing drainage holes;

FIG. 9 is an elevation view of the planter showing a pipe along the bottom of the planter that collects water from the drainage holes and carries the water to the bucket hanging from the pipe;

FIG. 10 is a close-up view of the irrigation pipe running along the inside rim of the trough; and

FIG. 11 is a perspective view of the planter with wheels.

### DETAILED DESCRIPTION OF THE INVENTION

The present invention provides a wheelchair-accessible planter. The invention also incorporates illuminating, irrigating and heating structures. The invention is supplied to practitioners as parts in a kit. The practitioner then easily, quickly and inexpensively assembles the planter with the improvements already installed in a planter specially designed to integrate all of these structures.

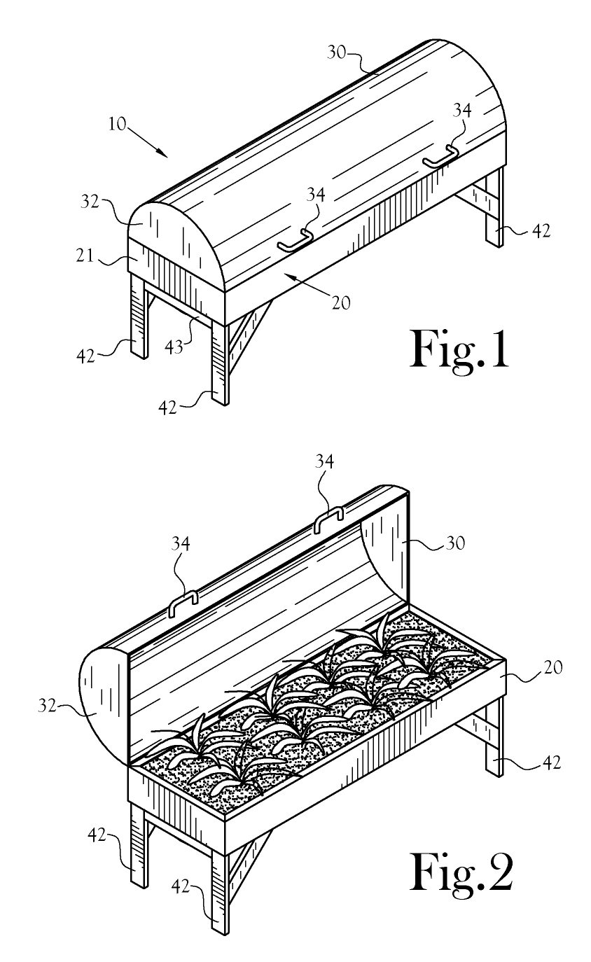

One embodiment of the invention includes a planter with a retractable canopy. Referring initially to FIG. 1, a planter is indicated generally at 10. The planter includes a substantially tubular trough 20 and a canopy 30. The canopy 30 lies on top of the trough 20. In one embodiment, the trough 20 and canopy 30 together constitute a cylindrical structure when the canopy 30 is in the “closed” position, resting atop and covering the trough 20. End walls 22 for the trough 20 and similar end walls 32 for the canopy 30 provide the substantially flat (non-curving) faces of the cylinder. The trough 20 normally is fabricated from plastic, a light-weight metal, or a similar substance of sufficient structural strength to support and contain plants and soil or other growth media. In some embodiments, the canopy 30 is fabricated from a translucent material so as to admit sunlight, as with the walls of a greenhouse.

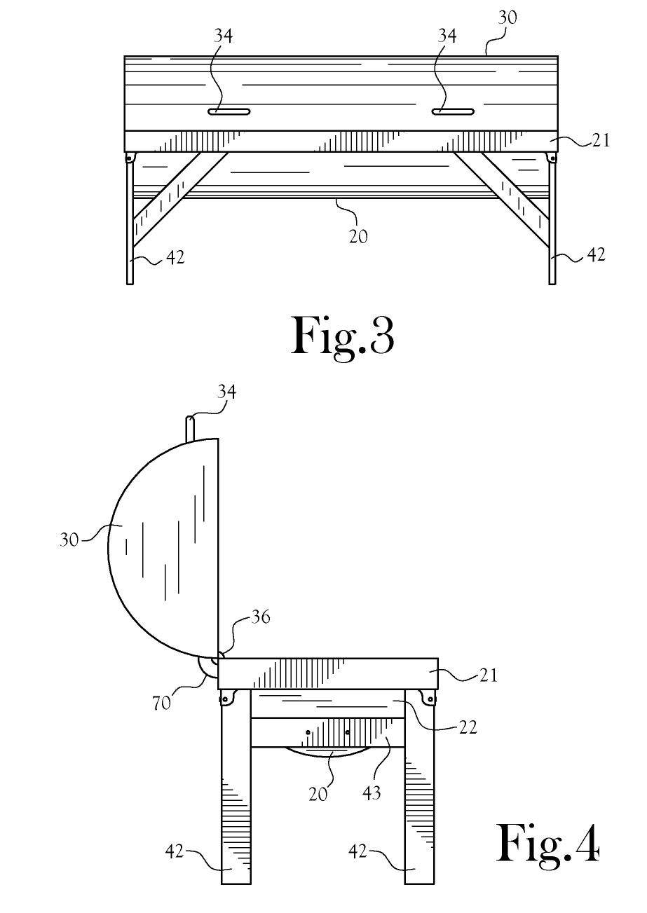

Referring to FIG. 2, it is seen that the canopy 30 retracts to reveal plants growing in media in the trough 20. As seen in FIGS. 1 and 3, one or more handles 34 on the canopy 30 assist the practitioner in raising the canopy from the “closed” position shown in FIG. 1 to the “open” position shown in FIG. 2. Referring to FIG. 4, the canopy switches between the “closed” and “open” positions by pivoting on one or more hinges 36. In the “open” position, a practitioner has access to the interior of the planter 10 and to the plants growing in the trough 20. In the “open” position, the practitioner is able to tend to the plants or to perform maintenance on the planter components. People familiar with the art will recognize that the degree to which the canopy must be raised in order for the practitioner to perform certain tasks will vary depending upon the practitioner, and therefore the degree to which the canopy is raised may vary, and so numerous “open” positions may exist.

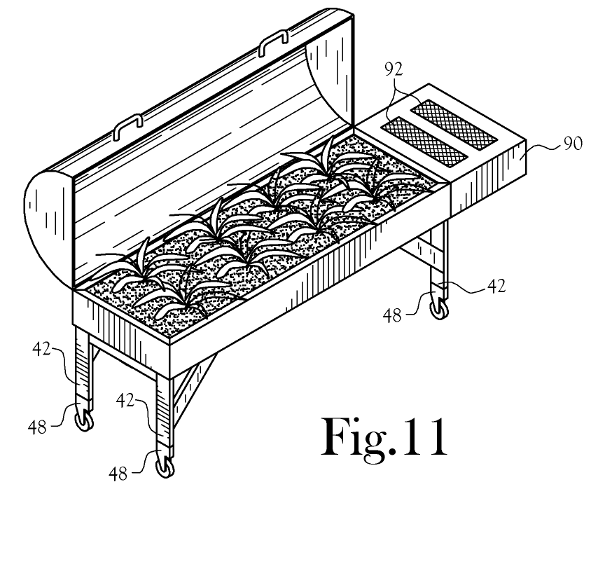

Referring again to FIG. 1, the trough 20 is raised above the ground by a number of legs 42. As seen in FIG. 5, the legs 42 are part of a larger support structure 40, which supports the trough 20, canopy 30, and other components of the planter that are elevated off the ground. In one embodiment, the support structure 40, in addition to the legs 42, also includes beams 44 in a substantially horizontal orientation. The trough 20 rests upon or is otherwise connected to these beams 44. In one embodiment, the various constituent parts of the support structure 40, including the legs 42 and the beams 44, are connected and held in place by braces 46. In other embodiments, wheels or rollers 48 attached to the bases of legs make the planter more mobile, as seen in FIG. 11.

The support structure 40 elevates the trough 20 above the ground to a height such that a person occupying a wheelchair may approach the planter and position the legs of said person and a portion of the wheelchair substantially beneath the trough 20.

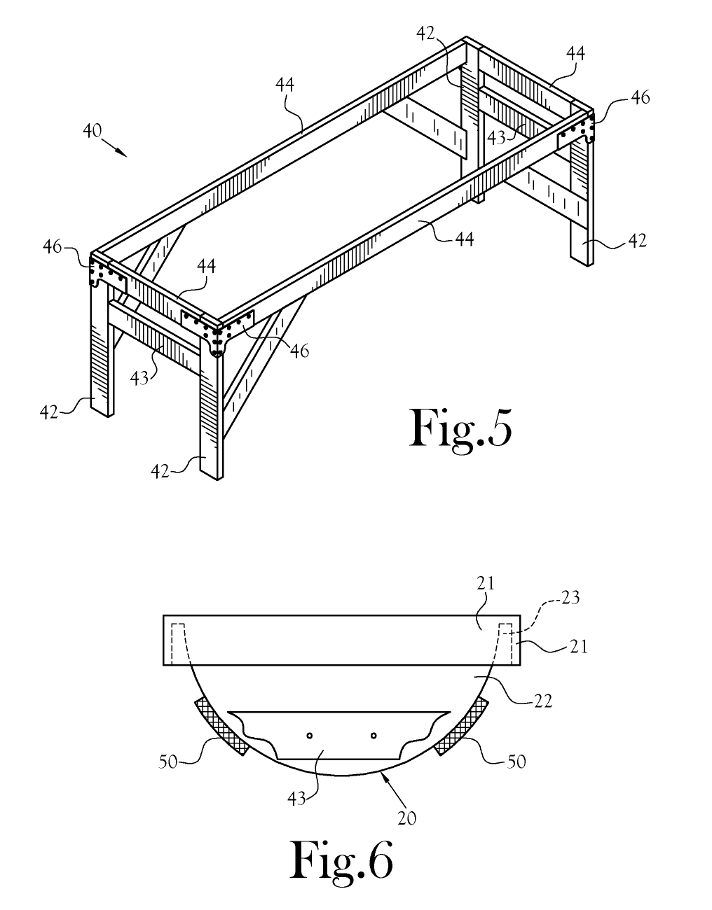

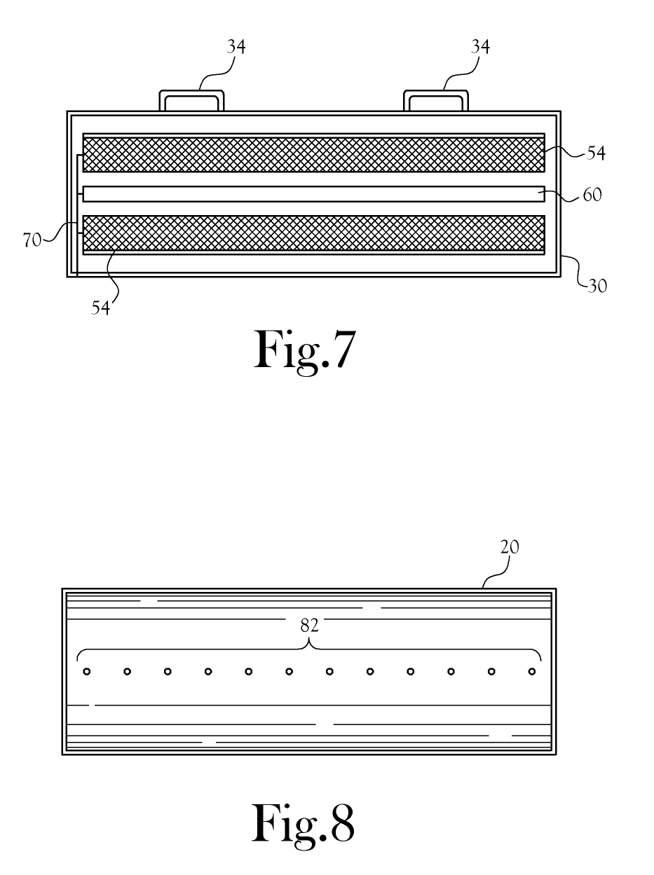

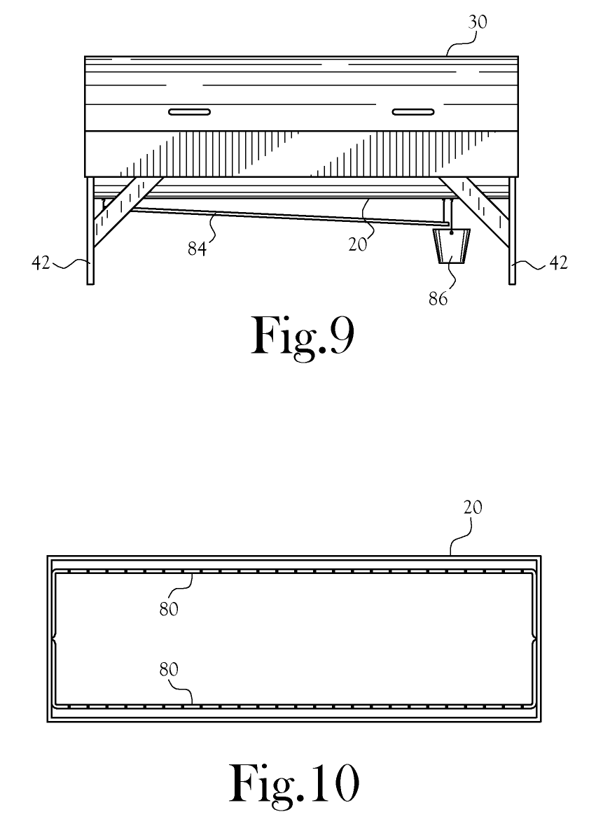

Heaters help to maintain within the planter a temperature conducive to growing plants. Referring to FIG. 6, in some embodiments heaters 50 are connected to the underside of the trough 20. In some embodiments one or more heaters 52 are also connected to the end wall 22 of the trough. Wires 70 connect the heaters to a power source. Referring to FIG. 7, in some embodiments heaters 54 are connected to the interior/underside (concave side) of the canopy 30. Wires 72 connect the canopy heaters to a power source.

A light source provides light for the plants when sunlight is not available or practicable. Referring to FIG. 7, one or more electric lamps 60 are connected to the underside of the canopy 30. The electric lamps 60 are connected to a power source through wires 70. Similar wires supply power to those electrically-powered structures connected to the trough 20. Referring to FIG. 4, said canopy wires 70 are connected to one or more wires 70 that link the canopy wires 70 to wires leading to the a power source. The wires collectively convey electrical power drawn either from an external power source or from solar panels 92, seen in FIG. 11.

Irrigation structures provide water to the plants growing within the trough 20. Referring to FIG. 10, in one embodiment, one or more tubes 80 line the rim of the trough 20. Water flows through the tubes 80, and said water is released through holes in the tubes 80 into the space where plants are growing in the trough. Referring again to FIG. 11, a pump 90 connected to the trough 20 or close nearby supplies water to the tubes 80, drawing the water from an external water source (such as a well or a garden hose connected to a residential water supply). Solar panels 92 or an external power source supply electricity to the pump 90.

Referring to FIG. 8, apertures 82 in the trough 20 allow excess water to drain from the trough. A gutter 84 suspended or positioned beneath the trough 20 collects the water flowing from the apertures 82. The gutter 84 then channels the water into a collection bucket 86 that hangs from the trough 20 or support structure 40.

As shown in FIGS. 3 and 6, in one embodiment, the depending sides 21 of the trough 20 are designed to extend over the beams 44 on opposite sides of the support structure 40. To this end, the support structure 40 is braced and the elongated beams are substantially covered by the depending sides or lips 21 on the opposite sides of the trough 20. FIG. 6 shows the opening 23 which receives the beams 44 for mounting the trough 20 on the support structure. Similarly, as shown in FIG. 4, the support structure 40 beams 44 at the opposite ends of the support structure are likewise received behind the depending lips 21 in the openings 23 defined between the end walls 22 of the trough 20 and the depending sides or lips 21 of the trough. The openings 23 (see FIG. 6) at the opposite ends of the trough are similar in cross-sectional outline to side openings 23 shown in FIG. 6. The only difference is that the end openings 23 are shorter than the side openings, and receive the end beams and side beams, respectively. By securing the opposite end walls 22 of the trough to the braces 43 at the opposite ends of the support structure, the lateral stabilization of the structure bearing the trough is enhanced.

All of the components described above can be supplied to consumers in the form of a kit, allowing a practitioner to assemble the device from pieces prefabricated for inclusion in the assembled invention.

While the present invention has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A planter comprising
a trough,
a retractable canopy, and
a support structure that elevates the trough to a height such that a person occupying a wheelchair may approach the planter and position the legs of said person and a portion of the wheelchair substantially beneath the trough, said support structure leaving a substantially unobstructed space beneath the trough of sufficient size to allow a person occupying a wheelchair may approach the planter and position the legs of said person and a portion of the wheelchair substantially beneath the trough.

2. The planter of claim 1 wherein the canopy is fabricated from a material sufficiently translucent to allow the penetration of some sunlight into the trough.

3. The planter of claim 1 wherein the support structure comprises a plurality of legs and cross-beams.

4. The planter of claim 3 wherein the support structure comprises four legs.

5. The planter of claim 1 wherein heating structures are connected to the exterior of the trough.

6. The planter of claim 1 wherein heating structures are connected to the interior of the canopy.

7. The planter of claim 1 wherein illumination structures are connected to the interior of the canopy.

8. The planter of claim 1 wherein irrigation structures are connected to the interior rim of the trough.

9. The planter of claim 1 wherein the support structure rests on wheels.

10. A wheelchair accessible planter comprising
a trough suitable for holding plants and growing media,
a retractable canopy, and
a support structure comprises a plurality of legs, said support structure elevating the trough above the ground to a height such that a person occupying a wheelchair may approach the planter and position the legs of said person and a portion of the wheelchair substantially beneath the trough.

11. A planter comprising
a trough suitable for holding plants and growing media, said trough including holes at the base of the trough of sufficient size to allow excess water to escape from the planter,
a gutter for collecting excess water removed from the planter through said holes at the base of the trough,
a retractable canopy,
a support structure comprises a plurality of legs, said support structure including side and end beams for supporting and elevating the trough above the ground to a height such that a person occupying a wheelchair may approach the planter and position the legs of said person and a portion of the wheelchair substantially beneath the trough, said trough defining an opening on the sides and end thereof to receiving said end beams therein,
heaters connected to the planter,
a light source within the canopy,
an irrigation structure, and
a pump that supplies water to said irrigation structure.

12. The planter of claim 11 wherein solar panels supply electrical power to the pump.

13. The planter of claim 11 wherein solar panels supply electrical power to all components that require electricity for normal operations.

14. The planter of claim 11 wherein the light source within the canopy is an electric lamp capable of producing electromagnetic radiation, said electromagnetic radiation including electromagnetic radiation having wavelengths within that portion of the electromagnetic spectrum that includes the light necessary for photosynthesis.
